(19) United States
(12) Patent Application Publication
(10) Pub. No.: US 2017/0053299 A1
(43) Pub. Date: Feb. 23, 2017

(54) SYSTEM AND METHODS FOR EFFECTIVELY TAKING SURVEYS USING MOBILE DEVICES

(71) Applicant: SWURVEYS, INC., SEATTLE, WA (US)

(72) Inventors: ZACHARY ROZGA, SEATTLE, WA (US); RUBY LOVE, SEATTLE, WA (US); FILIVAA MAGEO, SEATTLE, WA (US)

(21) Appl. No.: 15/239,621

(22) Filed: Aug. 17, 2016

Related U.S. Application Data
(60) Provisional application No. 62/207,847, filed on Aug. 20, 2015.

(51) Int. Cl. G06Q 30/02

(52) U.S. Cl. CPC G06Q 30/0203

(57) ABSTRACT

Systems and methods for more effectively obtaining and understanding a person's responses to a survey, poll, or questionnaire, specifically for persons providing a response using a mobile device (such as a smartphone). In some embodiments, a user of a mobile device may be provided with a survey or poll and asked to respond by using a gesture, a combination of a gesture and an audio input, a combination of a gesture and a key press, etc. The provided gesture may be one or more of a swipe (left or right, up or down), movement of an indicator along a scale, selection of one of a limited number of choices, etc. Survey taker response data and/or associated metadata may be used to determine which of a set of possible actions or events to present to the taker after completion of the survey.

### CROSS REFERENCE TO RELATED APPLICATION

This application claims the benefit of U.S. Provisional Application No. 62/207,847, entitled “System and Methods for Effectively Taking Surveys Using Mobile Devices,” filed Aug. 20, 2015, which is incorporated by reference herein in its entirety (including the Appendix) for all purposes.

### BACKGROUND

Surveys, polls, discussion groups, and other forms of seeking user responses are commonly used for collecting information about products, services, opinions, etc. Such information may be of interest to political candidates, marketing personnel, product developers, service providers, or employers, among others. Unfortunately, conventional forms of presenting surveys, polls, questionnaires, or other ways of obtaining user responses are often cumbersome, time-consuming, or impractical for certain user devices or environments.

For example, in responding to conventional surveys, polls, and questionnaires a user may be required to enter multiple text strings, provide comments, or otherwise engage with a question in a manner that is often time-consuming or inconvenient. This leads to incomplete or spurious responses, and/or a relatively low response rate. Both of these unfortunate and undesirable situations reduce the effectiveness and reliability of conventional surveys, for example.

While is it difficult enough to obtain useful responses in reply to a survey or poll that is replied to by a user using desktop device, it is even more difficult when a survey or poll is directed to users using mobile devices. Some of the reasons for this include characteristics of the device itself (smaller screens, more limited or inefficient capabilities for text entry, potential connectivity issues, etc.) and/or of the environment in which a user may be using the device to respond (such as one in which the user is multi-tasking, on-the-go, moving between locations, has a limited attention span, etc.).

Embodiments of the invention are directed toward solving these and other problems regarding the use of mobile or portable devices such as smart phones, tablets, laptops or similar devices for responding to surveys or polls, individually and collectively.

### SUMMARY

The terms “invention,” “the invention,” “this invention” and “the present invention” as used herein are intended to refer broadly to all of the subject matter described in this document and to the claims. Statements containing these terms should be understood not to limit the subject matter described herein or to limit the meaning or scope of the claims. Embodiments of the invention covered by this patent are defined by the claims and not by this summary. This summary is a high-level overview of various aspects of the invention and introduces some of the concepts that are further described in the Detailed Description section below. This summary is not intended to identify key, required, or essential features of the claimed subject matter, nor is it intended to be used in isolation to determine the scope of the claimed subject matter. The subject matter should be understood by reference to appropriate portions of the entire specification of this patent, to any or all drawings, and to each claim.

Embodiments of the invention are directed to systems and methods for more effectively obtaining and understanding a person's responses to a survey, poll, or questionnaire, specifically for persons providing a response using a mobile device (such as a smartphone). In some embodiments, a user of a mobile device may be provided with a survey or poll and asked to respond by using a gesture, a combination of a gesture and an audio input, a combination of a gesture and a key press, etc. The provided gesture may be one or more of a swipe (left or right, up or down), movement of an indicator along a scale, selection of one of a limited number of choices, etc.

In some embodiments, a central server or other form of data processing platform may receive the responses from multiple users' mobile devices and process the data separately or in aggregate to identify trends, indicia of a more or less effective survey or poll (based on response times, response rates, reliability of responses, etc.). The survey or poll takers' responses may be processed and evaluated for each survey or poll maker separately and/or in aggregate to identify characteristics of an effective or desirable survey or poll. In some embodiments, data analytics may be used to determine a best or optimal type or class of gesture or other user input in order to obtain a desired response rate and reliability for a specified question or comment.

In some embodiments, a set of tools or recommendations may be provided to a survey or poll creator or maker that can be used to assist that entity to create a more effective and reliable survey or poll. In some embodiments, the central server or other form of data processing platform may be a multi-tenant data processing platform in which multiple survey or poll creators/makers may each have an account and access to a specific set of account management, survey or poll creation, and data analysis tools or applications.

In one embodiment, the invention is directed to a system for creating, distributing, and evaluating the results of a survey or poll taken by one or more survey takers by submitting a response using a mobile device, where the system includes:
a set of executable instructions stored in an electronic data storage element;
an electronic processor programmed to execute the set of instructions, which when executed cause the system to implement a process or processes to
enable a survey maker to create a survey or poll;
enable the created survey or poll to be distributed to the one or more survey takers;
receive data representing each taker's response to the distributed survey or poll, the received data including data representing one or more non-textual interactions with a display of a mobile device associated with the taker;
process the received data to determine each taker's responses to the survey or poll;
generate a display or other form of communication of a result of the processing of the received data to the survey maker;
present to a survey or poll taker, or to a set of survey or poll takers, one or more actions or events that may be initiated, the one or more actions or events based on the taker or takers responses; and
determine a charge or cost for the services provided by the system.

Other objects and advantages of the present invention will be apparent to one of ordinary skill in the art upon review of the detailed description of the present invention and the included figures.

### BRIEF DESCRIPTION OF THE DRAWINGS

Embodiments of the invention in accordance with the present disclosure will be described with reference to the drawings, in which:

FIG. 1 is a diagram illustrating elements or components of an example operating environment in which an embodiment of the invention may be implemented;

FIG. 2 is a flowchart or flow diagram illustrating a process, method, function, or operation that may be used in implementing or using an embodiment of the inventive system;

FIG. 3 is a block diagram illustrating aspects of the architecture of a system used to implement an embodiment of the inventive system and methods;

FIGS. 4-8(e) illustrate displays and implementation details that may be relevant to one or more embodiments or use cases of the inventive system and methods;

FIG. 9 is a diagram illustrating a possible set of screen displays and an overall process flow that may be presented to a survey taker as part of an implementation of an embodiment of the inventive system;

FIG. 10(a) is a diagram illustrating examples of the types of actions or events that a survey or poll taker may initiate as part of completing the survey or poll, or in response to receiving the results of processing the data and/or metadata associated with the survey or poll;

FIG. 10(b) is a diagram illustrating how a survey taker's response or responses as compared to those of other takers may be used to determine which action(s) to encourage and how to select those actions;

FIG. 10(c) is a diagram illustrating aspects of a process for generating revenue from providing the services related to survey or poll creation, distribution, and response data and metadata processing that are associated with an embodiment of the inventive system and methods; and

FIG. 11 is a diagram illustrating elements or components that may be present in a computer device or system configured to implement a method, process, function, or operation in accordance with an embodiment of the invention.

Note that the same numbers are used throughout the disclosure and figures to reference like components and features.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the invention will be described more fully hereinafter with reference to the accompanying drawings, which form a part hereof, and which show, by way of illustration, exemplary embodiments by which the invention may be practiced. This invention may, however, be embodied in many different forms and should not be construed as limited to the embodiments set forth herein; rather, these embodiments are provided so that this disclosure will satisfy the statutory requirements and convey the scope of the invention to those skilled in the art.

Among other things, the present invention may be embodied in whole or in part as a system, as one or more methods, or as one or more devices. Embodiments of the invention may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, controller, etc.) that is part of a client device, server, network element, or other form of computing or data processing device/platform and that is programmed with a set of executable instructions (e.g., software instructions), where the instructions may be stored in a suitable data storage element. In some embodiments, one or more of the operations, functions, processes, or methods described herein may be implemented by a specialized form of hardware, such as a programmable gate array, application specific integrated circuit (ASIC), or the like. The following detailed description is, therefore, not to be taken in a limiting sense.

Embodiments of the invention are directed to systems and methods for more effectively obtaining and understanding a person's responses to a survey, poll, or questionnaire, specifically for persons providing a response using a mobile device (such as a smartphone or personal digital assistant). In some embodiments, a user of a mobile device may be provided with a survey or poll and asked to respond by using a gesture, a combination of a gesture and an audio input, a combination of a gesture and a key press, etc. The provided gesture may be one or more of a swipe (left or right, up or down), movement of an indicator along a scale, selection of one of a limited number of choices, etc.

In some embodiments, the invention is directed to a system that implements one or more machine learning techniques (or other advanced data analysis method) to identify an offer to present to a survey or poll taker based at least in part on the answers they provide when compared to the answers provided by other takers, and in some cases, the result of analyzing response related metadata. Such an offer may include one or more of a discount, a suggestion to apply for a membership, a suggestion to volunteer for a program, a suggestion to perform a specific business activity, an invitation to join a social network, an invitation to share the results of the survey or poll with a set of contacts or other audience, an invitation to see all the results, etc.

The responses from one or more survey or poll takers may be received and processed by a central data processing platform or server. The responses may be processed to determine the takers' sentiments, and also to identify how the format of a specific survey or poll may have affected the response rate and/or reliability. In some cases, processing of aggregate user response data (that is data from multiple users responding to a single poll and/or users responding to more than a single survey or poll) may be performed to assist in identifying preferred or optimal survey or poll formats, preferred or optimal types or classes of taker inputs (gestures, combinations of gestures with other inputs, etc.), or to provide other forms of guidance to survey or poll makers.

In some embodiments, the inventive system and methods replace one or more buttons, boxes, or text fields with motions, swipes and/or gestures. This permits ease of capturing the thoughts or opinions of a user with a mobile device, while still allowing a relatively wide range or responses (which may be required or desired for certain issues, questions, decisions, etc.). The inventive system and methods are designed to focus on the survey “taker” versus the survey “maker”. This impacted the design and implementation, as the features or operations of the inventive system and methods are intended to make it easier for a user to answer the question “authentically”, make it more or less likely for a user to finish the survey without gathering new information or capturing some subtlety of the user or question, or be more or less likely to improve the survey taker experience.

In some embodiments, metadata regarding certain aspects of a survey or poll taker and their responses may be collected and processed by the central data processing platform. Such data or metadata may include, but is not limited to (or required to be) one or more of:
user response time for a specific question;
time between responses to consecutive questions or between responses to specific questions;
user “linger” time—may indicate indecision about response or stronger interest in content;
the pressure applied by a user when entering a gesture or response motion;
directness of the user response motion along a path;
variability of the user applied pressure along a path;
indications of user engagement (or lack of) with a question;
user demographic information and its relationship to user behavior in responding to a survey, etc.; or
user geographical location or indications of movement when they respond to a survey or poll question.
   In some embodiments, the metadata may be processed and analyzed to assist with survey design and implementation, with a goal of increasing and improving overall response rates and the reliability of user responses (and hence the quality of the survey protocol). When survey “makers” are part of the design process, the inventive system may alert the maker to best practices that will increase the chance of getting the best responses or most reliable responses based on the metadata analysis.

In some embodiments, user metadata may be used to determine a best or optimal mapping between possible user motions or gestures with respect to a device and an aspect of a survey or poll; this may have a goal of identifying those classes or forms of gestures (left-right swipe, up-down swipe, placement of an indicator on a scale, etc.) that will be most effective at capturing a user's thoughts or responses to a particular question or topic. This may include one or more of selection of the type of indicators to use as a function of the audience and/or survey question (swipe up, finger press, finger outline of an arc, etc.), the types of collectable metadata and its possible uses (such as timing data, user linger data, user confidence data as a function of finger pressure, user satisfaction with the survey experience as a function of average response time, etc.), and the mapping of various motions or indicators to possible responses to a question (based on expected user attitudes towards possible responses, the expected range of possible responses, the most effective ways of capturing certain user responses, the most effective ways of capturing indications of user sentiment, etc.).

As described, data and information obtained from the processing of metadata (in conjunction with or separate from user response data) related to surveys or polls (or to survey or poll takers) may be used to assist in the development of survey or poll questions, or in the selection of a survey or poll format most likely to provide meaningful information. Such data and information may also be used as part of a decision tool or recommendation process; for example, the results of processing user responses and/or response associated metadata may be used to determine one or more of:
a possible follow up action to present to a user (survey taker), such as
   the ability to share the results using social media, email or text; or
   the ability for the taker to be able to access all of the results of the survey or poll, and to learn how their responses compare to those of a larger group;
an advertisement or action to present to a user
   the questions that are answered by the user can be evaluated/analyzed (using machine learning techniques, for example) in comparison to the entire population of takers (for the current survey, a previous survey, all previous surveys, etc.), and using appropriate logic, a data point (or points) may be selected to display to the user/taker in order to encourage them to click/accept an offer or invitation; this is a way to encourage a taker to participate in the same event or action that those having a similar response or responses participated in (note that in a sense, this finds those responses that a taker has most in common with a larger group and uses that information to select a proposed next action). Similarly, the system can display an advertisement that is selected for the specific taker based on their responses (either alone or in comparison to those of other takers). In one approach, a taker's responses are used to find a larger group of takers (current or previous) having sufficiently similar responses, and then an advertisement is selected that would be expected to appeal to that group (note that in some sense, this is a form of collaborative filtering);
a recommendation of a product or service to provide to a user
   this may be part of encouraging an eCommerce transaction such as the purchase of a product—this may be implemented in a manner similar to that described for serving an advertisement—the recommendation could be supplemented by a link to a review, takers' comments regarding the product or service, a link to a form for initiating the transaction, etc.;
a link to information believed to be of value or interest to a user (e.g., a map, an article, an image, an audio file etc.)—this may be implemented in a manner similar to that described for serving an advertisement—the content being linked-to would depend upon the taker's responses and/or response related metadata, either individually or when compared to other takers;
an invitation to join a social network or local group composed of survey or poll takers having similar responses or a similar range of responses to others taking the same survey or poll, or the same set of surveys or polls
   note that if a taker's responses and/or metadata do not put them within a certain “closeness” to those of others, then such an invitation would not be generated—further, each network or group may set its own criteria for what constitutes a desirable member based on the variance between the prospective member's responses and/or metadata and that of current members;
a link to enable a taker to make a donation to a cause or candidate;
a link to enable a taker to volunteer for a task or activity;
a link to initiate a reservation process or to cause a reservation process to execute;
a link to enable a taker to register for an event or to cause a registration process to execute
a video or game offered to a taker;
a process to enable a taker to “sign a petition”;
a process to enter a competition; or
a specific business related activity to provide to a taker (check out of a hotel, access a Wi-Fi hotspot, connect to customer service or support, etc.).

Note that studies indicate that consumers and other users are interested in knowing how their opinion compares to the majority or to a set of other takers (this conclusion is found through social media, polls, and other data driven outlets). Where most surveys or pops remain private, embodiments of the inventive system and methods provide one or more real-time data point(s) to the respondent/taker to indicate to them information about their responses in comparison to others. As a result, the inventive system makes it possible for a respondent to know how their opinion fits in with a larger group, which ultimately may influence their behavior. This is in contrast to conventional systems and methods of distributing and processing the responses to surveys or polls, where data collection and encouraging/taking a certain action are largely independent of each other (and are not contemporaneous with the taking of the survey or poll).

In addition the inventive system and methods provide a mechanism for enabling makers to encourage, and takers to engage in, actions that are contemporaneous or nearly contemporaneous with the taking of a survey or poll; this takes advantage of the fact that people typically have their mobile device with them when shopping, selecting a restaurant, or attending an event. As a result, a business or organization can distribute a survey or poll to a set of prospective customers, and based on their responses, seek to encourage the survey takers to engage in a desired behavior while they are nearby the business or a scheduled event (such as a sale, product demonstration, social or political rally, meeting, concert, special event, etc.), or are particularly motivated to take an action after having taken the survey.

In some embodiments, the inventive system/platform may include a mobile communications system/network and a device that facilitates using a variety of gestures to answer questions or input data. This may include an HTML5 web based browser or plug-in that the survey maker can make available to users (this is preferable to having users download an app across all mobile platforms, although this option may be available for some devices or operating systems). Although mobile devices/platforms such as smart phones and tablets are expected to one area in which the inventive gesture-driven user interface will be employed, the system and methods can be migrated to other systems and platforms where motions or gestures can be tracked and interpreted (e.g., Microsoft Kinect or PlayStation, VR, Google Glass, Oculus Rift, HTC Vive, Samsung Gear VR etc.). In some cases, these devices have their own methods for user input, and the concepts and methods underlying the inventive system and methods may be modified to accommodate these. For example, a Google Glass or Samsung Gear VR user may be enabled to use head movements to indicate survey choices, or an Oculus Rift or HTC Vive user may be enabled to use the platform's hand controls to “virtually” swipe a virtual deck of cards representing the survey.

In a typical implementation, a server or platform may provide a web page to a mobile device in which is installed a browser or other application. The web page may contain a question, statement, or other form of information. The browser will cause a display of the web page to the user of the device and enable the transmission of the user's interactions with the device to the server or platform over a suitable communications network (e.g., a wireless network coupled to the Internet). The server or platform may be operated by the survey maker or administrator, or by a third party (such as an operator of a multi-tenant data processing platform that provides survey creation, distribution, and response processing services for multiple survey makers or organizations).

The survey or poll development process may impose restrictions on the possible user input(s); for example, these may be restricted to only swipe motions and gesture based input(s), or to motions captured by a camera, as opposed to keyboard and mouse based inputs. Such a restriction makes the mobile experience the central environment for the survey or poll, instead of being a secondary delivery channel. Further, since the survey or poll is mobile based, embodiments of the inventive system and methods may take advantage of technologies and mechanisms inherent to the mobile device environment, such as push notifications, GPS location, physical device movement, secure mobile payments, social media feeds, and sharing. These are functions or mechanisms that, while existing in some form on some traditional computers, are the primary experience drivers for mobile devices.

In some cases, the mobile device versions of these technologies can be easily utilized to drive traffic to, and increase awareness of, the survey. Geo-fencing may be used at events or festivals, thereby engaging users as they enter or leave a venue. In this case, GPS may be used to detect that a user is entering or leaving the venue, while push notifications are used to engage the user. Surveys may offer coupons or vouchers as incentives for taking a survey, which can integrate with the user's secure mobile payment platform, such as Android, Samsung, or Apple Pay. As another example, after a user completes a survey, they may touch their mobile device to another person's mobile device at the same festival, thereby using Near-field Communication (NFC) or another suitable communications technology to transfer the survey as well as a referral code, so that the original user is rewarded after the second user completes the survey.

In addition, because the survey or poll environment and user experience is mobile based, embodiments may utilize mobile related aspects of the survey taker (the user of the device) that might not normally be relevant or as relevant; these may include, but are not limited to (or required to include):
user speed of response after first presentation of question or statement;
user's speed of moving from one question or statement to another;
how fast or intense the user's gesture or facial expressions are when responding, thereby providing a form of sentiment analysis and assisting in gauging the user's enthusiasm, emotion or excitement;
the number of surveys or polls taken by a user within a certain timeframe, within a certain category or within a certain location (e.g., a user may be more likely to take a survey on their public transit commute then when they are at home with their family);
the types of surveys or polls that a given user takes, and thus the likely interests of the user;
geolocation capabilities to enable using that information to select and/or process a survey or poll; or
use of the immediacy of the experience (e.g., a person walks out of a game and receives a survey about the experience on the way out).
   Note that at least some of this information may be captured by using the capabilities of the mobile device itself; for example, the camera, the accelerometer, and the mobile device swipe motions may provide an indication of user interest, user sentiment, etc.

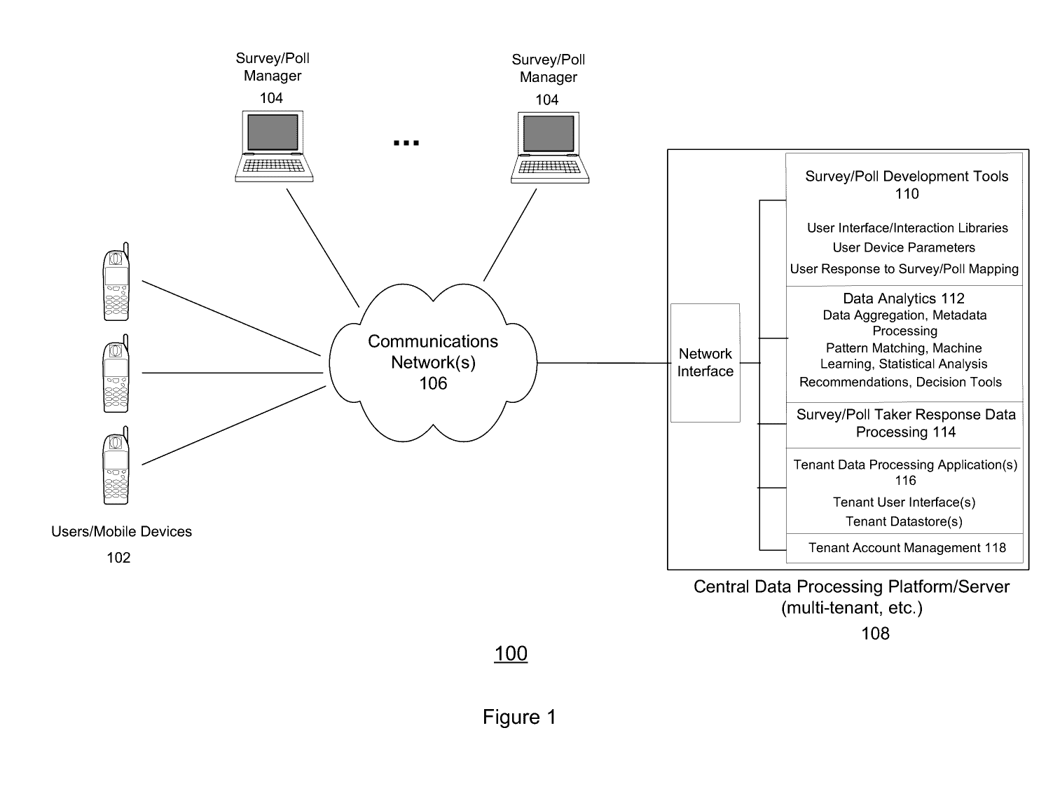

In some embodiments, the inventive system/platform may include survey administration and management capabilities that may be accessed by tents of the platform (such as aspects of elements 110 and 116 of platform 108 of FIG. 1) to enable a survey maker (typically a representative of a tenant of the platform) to create (i.e., author) a survey, poll, or other form of interaction with a device user, typically using the author's personal computer (which is communicatively coupled to server or platform 108 for purposes of data processing, analysis of user responses, aggregation of data, etc.). The administration or management capabilities (for example, as illustrated by certain of the processes or functional modules of elements 110 and 116 of platform 108) may provide a survey maker with suggestions, guidance, and tools to make the most effective or productive surveys/polls. Basic authoring capabilities may be provided for core development (Binary, Multiple Choice and Slider Scale/Likert Scale). As shown in FIG. 1, the platform 108 may include an analytics module/server/component (aspects of elements 112 and 114) that will enable a survey maker to manipulate and visualize the resulting data and/or measurements. Among other capabilities, the analytics service or processes will be configured to receive, measure, determine, and/or collect metadata about a survey and user responses in order to inform survey makers. The analytics center may use metadata to infer information or draw conclusions across geographies, survey taker groups, survey formats, or other measurable aspects.

As mentioned, in some embodiments, the invention may be implemented in the context of a multi-tenant, “cloud” based environment (such as a multi-tenant data processing platform), typically used to develop and provide (Internet) web-based services and business applications for end users (in this case both survey takers and survey creators/makers). Note that embodiments of the invention may also be implemented in the context of other computing or operational environments or systems, such as for an individual business data processing system, a private network used with a plurality of client terminals, a remote or on-site data processing system, another form of client-server architecture, etc.

For the purposes of this description, cloud services may be divided broadly into “low level” services and “high level” services. Low level cloud services (sometimes called “raw” or “commodity” services) typically provide little more than virtual versions of a newly purchased physical computer system: virtual disk storage space, virtual processing power, an operating system, and perhaps a database such as an RDBMS. In contrast, high or higher level cloud services typically focus on one or more well-defined end user applications, such as business oriented applications. Some high level cloud services provide an ability to customize and/or extend the functionality of one or more of the end user applications they provide; however, high level cloud services typically do not provide direct access to low level computing functions.

The ability of business users (in this case survey makers or administrators) to access crucial business information has been greatly enhanced by the proliferation of IP-based networking together with advances in object oriented Web-based programming and browser technology. Using these advances, systems have been developed that permit web-based access to business information systems, thereby allowing a user with a browser and an Internet or intranet connection to view, enter, or modify business related information (such as survey results, processed survey data, a dashboard showing a distribution of responses based on one or more survey or survey taker parameters, etc.).

Aspects of the inventive system and methods may be hosted on a distributed computing system made up of at least one, but possibly multiple, “servers.” A server is a physical computer dedicated to providing data storage and an execution environment for one or more software services/applications intended to serve the needs of the users of other computers that are in data communication with the server, for instance via a public network such as the Internet or a private “intranet” network. The server, and the services it provides, may be referred to as the “host” and the remote computers, and the software applications running on the remote computers, being served may be referred to as “clients.” Depending on the computing service that a server offers it could be referred to as a database server, file server, mail server, print server, web server, etc. A web server is a most often a combination of hardware and the software that helps deliver content, commonly by hosting a website, to client web browsers that access the web server via the Internet.

FIG. 1 is a diagram illustrating elements or components of an example operating environment 100 in which an embodiment of the invention may be implemented. As shown, a variety of client processes or modules incorporating and/or incorporated into a variety of computing devices (such as mobile devices 102) may communicate with a central data processing/computing platform 108 through one or more networks 106. A survey maker or administrator 104 may also communicate with platform 108 via a suitable network or networks 106, typically by using a desktop computing device or terminal.

For example, a client may incorporate and/or be incorporated into a client application (e.g., software) implemented at least in part by one or more of the computing devices 102. Examples of suitable computing devices include tablet computers or personal digital assistants (PDAs), smart phones, cell phones, and consumer electronic devices incorporating one or more computing device components, such as one or more electronic processors, microprocessors, central processing units (CPU), or controllers. Examples of suitable networks 106 include networks utilizing wired and/or wireless communication technologies and networks operating in accordance with any suitable networking and/or communication protocol (e.g., a wireless network coupled to the Internet).

The data processing platform (which in some cases may be a multi-tenant data processing platform) 108 may include multiple processing tiers or functional modules. These tiers or modules operate to provide each tenant or account (which may be associated with one or more survey or poll makers) with tools to create, administer, and evaluate the results of their respective survey or poll. Generally, each survey maker (or set of makers, such as those employed by a single entity/tenant) will be associated with an account maintained on platform 108. Tenant Account Management process or module 118 functions to permit a tenant/survey maker to register for an account, including providing a username or account name and authentication data (such as a password). Account Management process or module 118 may also be responsible for receiving and processing tenant credentials (such as username and password) to authenticate a tenant user and permit access by that entity (such as one or more survey/poll manager 104 in FIG. 1) to data and information on platform 108. This may enable a tenant user to construct a survey or poll, determine a desired set of survey or poll takers, distribute the survey or poll to those takers, receive data regarding the takers response(s), process the received response data, and make the processed data available to the tenant user. One or more of the services (such as data processing applications, data storage, etc.) resident on or accessible via platform 108 may be provided to tenant users as a web-service or a form of Software-as-a-Service (SaaS).

Other elements or processes that may be resident on platform 108 and available to tenant users, may include but are not limited to (or required to include):
Survey/Poll Development Tools 110—these may include features, processes, functions to enable a tenant user (such as one of Survey/Poll Manager 104) to construct a survey or poll having desired characteristics—such features, elements, etc. may include:
   one or more libraries of suitable user interface elements that may be selected for use (such as shapes, images, indicators, etc.);
   one or more libraries of possible user interactions (which may depend on user demographics or characteristics, and/or device characteristics) and represent ways in which a survey taker may respond to a question or statement (such as a swipe, a press on a key or display screen element, move a marker, use a gesture in association with a key press or audio input, etc.);
   one or more libraries of device parameters/characteristics (which may provide information used to determine which user interface elements and/or user interactions are available or most suitable for a specific device or network); and
   enabling a survey maker to construct one or more mappings between received user responses (such as gestures, a gesture combined with a key press, a gesture combined with an audio input) and specific survey or poll responses (such as specific answers or values);
Survey/Poll Taker Response Data Processing 114—these elements or processes may include functions, operations, models, applications, or other forms of mathematical/statistical processes that may be used to pre-process, analyze and evaluate the responses received from survey takers from their respective mobile devices 102 over network(s) 106—typically, these may be selected by the survey maker or administrator to assist in understanding the survey or poll results from a specific survey or set of survey takers, but may also be recommended by platform 108 (such as by the Data Analytics processes 112) based on characteristics of the survey, the devices, the survey takers, etc. Such functions, operations, models, applications, or other forms of mathematical/statistical processes may include machine learning, statistical analysis, clustering algorithms, pattern matching, etc.;
Data Analytics 112—these elements or processes may include functions, operations, models, or other forms of mathematical/statistical processes that may be used to analyze and evaluate the response data and/or metadata received from multiple survey takers and/or accounts in order to generate insights into the operation of the platform and/or survey creation, distribution, and processing operations—such features, elements, operations, functional capabilities may include:
   capabilities for aggregating the metadata for multiple survey takers across one or multiple survey maker accounts;
   enabling the application of machine learning and/or other advanced data mining and analysis techniques to assist in identifying one or more survey, survey taker, or device characteristics that contribute to specified goals or results;
   enabling the generation of recommendations with regards to survey construction, survey contents, desired survey takers, desired devices, etc. where applicable to assist survey makers or administrators to achieve better response rates and more reliable responses; and
   generating recommendations or content to provide to a user or set of users based on one or more of survey responses, survey/user associated metadata, behavioral models, etc.; and
Tenant User Data Processing Applications 116—such features, elements, etc. may include:
   data processing techniques or applications (including proprietary ones specific to, or specifically developed for, a tenant) for use by one or a set of authorized tenants/accounts (such as value-add or tenant developed data processing applications or extensions to such applications). This may include features such as the platform automatically sending results to a tenant application in real-time as responses are collected, or an application programming interface (API) enabling a tenant to create a survey from their own platform in certain use cases and embed the survey analytics in their own platform. This may also include a possible taker “action” that involves contacting a tenant's platform to generate a one-time use coupon or voucher (effectively in real-time) for the taker/user;
   tenant specific user interfaces (for interacting with platform 108) and/or tenant specific user interface elements (for use in generating surveys and which may differ from those available from Survey/Poll Development Tools 110). This may include a representation of the geographic location of a business or organization providing a survey on a map or by use of an augmented reality (AR) application, so a user can view a survey superimposed on an image or live camera image of a business. This may also include using laser tracking technology to enable a taker/user to wave their hands to provide a response to a survey at a workstation in a business or festival venue; and
   tenant specific datastores and libraries—these represent tenant specific data and may include survey taker responses to tenant generated surveys, processed survey taker data, results of tenant modeling of survey responses, tools for presenting survey results used by a specific tenant (such as dashboards, displays, charts, etc.), etc. This may also include the tenant's authentication system being integrated with the survey, such that only registered customers of the tenant platform can take the survey and can only take the survey a single time.

Note that the Survey/Poll Manager 104 for a specific tenant account or accounts may interact with platform 108 to create, generate, or author a survey, distribute the survey to a desired set of survey takers/mobile devices 102, manage the processing of the survey responses, analyze or evaluate the survey results alone or in aggregate, and determine how to present those results through interactions with the various functions or processes available on platform 108. In some cases, results may be presented to Survey/Poll Manager 104 via a dashboard or other graphic and/or textual format.

As noted, platform 108 may include tenant/account owner specific user interfaces and datastores. The user interfaces may include graphical user interfaces and/or web-based interfaces. The user interfaces may include a default user interface for the platform to provide access to applications and data for a tenant of the platform, as well as one or more user interfaces that have been specialized/customized in accordance with tenant specific requirements. The default user interface may include components enabling a tenant to administer the tenant's participation in the functions and capabilities provided by the service platform, such as accessing data, causing the execution of specific data processing operations, etc. Each functional or processing tier or set of processes illustrated in the figure (or used to implement an embodiment of the inventive system) may be implemented with a set of computers and/or computer components including computer servers and processors, and may perform various functions, methods, processes, or operations as determined by the execution of a software application or set of instructions.

The tenant-specific user interfaces or user interface elements may include elements used by a Survey/Poll Manager 104 associated with a tenant (such as a survey or poll distribution entity) to create and execute a desired data processing workflow on the received response data and/or metadata. The tenant-specific user interfaces or user interface elements may also include definitions or representations of device user swipes or interactions with a device that the tenant may desire to be used in responding to their surveys or polls.

Each tenant datastore may contain tenant-specific data (device user response data, device user metadata, tenant account or business information, tenant specifications for surveys or survey data processing, etc.) that is used as part of providing a range of tenant-specific services or functions, including but not limited to survey creation and distribution, survey response evaluation and analysis, generation of recommendations, decision tools, metadata processing and analysis, storage and marketing of data obtained from takers of surveys provided to the takers by the tenant, etc. Datastores may be implemented with any suitable data storage technology, including structured query language (SQL) based relational database management systems (RDBMS).

As noted, in accordance with one embodiment of the invention, data processing service/platform 108 may be multi-tenant and may be operated by an entity (such as the Assignee of the present application) in order to provide multiple tenants (e.g., survey or poll distribution companies, marketing consultants, businesses, governmental entities, etc.) with a set of related applications, data storage, and functionality. These applications and functionality may include ones that a survey maker/tenant uses to manage various aspects of its operations as they relate to surveys or polls. For example, the applications and functionality may include providing web-based access to certain business information systems, thereby allowing a tenant with a browser and an Internet or intranet connection to view, enter, process, or modify certain types of information.

Thus, by means of a multi-tenant data processing platform or other form of “web-service” platform, a survey maker or group of survey makers may utilize systems and processes provided by a third party. Such a third party may implement an integrated system/platform as described above in the context of a multi-tenant platform, wherein individual instantiations of a single comprehensive integrated set of applications are provided to a variety of tenants. One advantage to such multi-tenant platforms may be the ability for each tenant to customize their instantiation of the system and processes to that tenant's specific business needs or operational methods. For example, each tenant may be a business or entity that uses the multi-tenant platform to provide surveys, polls, or other forms of interactions and functionality to multiple users (such as employees, survey takers, or customers).

In general, an embodiment of the invention may be implemented using a set of software instructions that are designed to be executed by a suitably programmed processing element (such as a CPU, microprocessor, processor, controller, computing device, etc.). In a complex system such instructions are typically arranged into “modules” with each such module performing a specific task, process, method, function, or operation. The entire set of modules may be controlled or coordinated in their operation by an operating system (OS) or other form of organizational platform.

Each tenant user interface may include one or more interface elements. For example, tenant users may interact with interface elements in order to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks and dialog boxes. Application programming interfaces may be local or remote, and may include interface elements such as parameterized procedure calls, programmatic objects and messaging protocols.

The platform's application or functional modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language.

Note that the example computing environment depicted in FIG. 1 is not intended to be a limiting example. Alternatively, or in addition, computing environments in which an embodiment of the invention may be implemented include any suitable system that permits users (such as survey makers or takers) to provide data to, and access, process, and utilize data stored in a data storage element (e.g., a database) that can be accessed remotely over a network. Further example environments in which an embodiment (or an aspect of an embodiment) of the invention may be implemented include devices (including mobile devices), software applications, systems, apparatuses, networks, or other configurable components that may be used by multiple users for data entry, data processing, application execution, data review, etc. and which have user interfaces or user interface components that can be configured to present an interface to a user. Although further examples may reference the example computing environment depicted in FIG. 1, it will be apparent to one of skill in the art that the examples may be adapted for alternate computing devices, systems, apparatuses, processes, and environments. Note that an embodiment of the inventive methods may be implemented at least partially in the form of an application, a sub-routine that is part of a larger application, a browser, a “plug-in”, an extension to the functionality of a data processing system or platform, or other suitable form.

This application includes information describing examples and/or details regarding one or more embodiments of the inventive system and methods described herein. Specifically, examples of displays and user interface elements that may be used as part of a survey or poll, and that would be presented to a survey user on their mobile device are described and illustrated. The displays also represent examples of a possible mapping (or mappings) between a survey taker's gestures or actions and a user's specific response to a survey or poll question or statement (or vice-versa). The use cases described represent examples of the types of survey or poll questions that may be asked of a survey taker, and of a manner in which such a survey or poll may be implemented on a survey taker's mobile device. They are not meant to be exhaustive or restrictive, but only to present examples of how certain features or aspects of the inventive system and methods may be implemented. Note that the examples may also suggest the type or range of user interface elements to present to a survey taker for use in responding to a survey or in capturing metadata of interest to the survey maker.

In general, the types or categories of metadata that may be collected and processed by an embodiment of the inventive system include but are not limited to (or required to include):
user speed of response to a question or statement;
user intensity of gesture in response (as determined by the pressure applied on the device screen, for example);
captured and processed facial expressions (using suitable image processing techniques to identify sentiment, mood, energy level, enthusiasm, etc.);
types, formats, categories of other surveys or polls that a given user takes;
number or frequency of other surveys that a user takes;
a measure of the aggregation of each user's responses versus the answers provided by the entire set of takers for a given survey, with further information provided by metadata analysis;
the mobile device hardware and software version; and
the number of questions a user answers before leaving the survey unfinished
   this information may be used to automatically leave out less important questions in future surveys in order to make it more likely that the user completes a survey, or to help a survey maker better understand what kinds or forms of questions cause users to disengage from a survey.

Note that at least some of this and/or other relevant metadata may be captured by utilizing the capabilities of the mobile device itself; this might include the camera, an accelerometer, information obtained from an API permitting access to signals from the device screen, etc. The captured data (user response data and/or metadata) is provided to a cloud-based data processing platform (such as that described with reference to FIG. 1). The data may then be aggregated into one or more cloud-based databases for further processing and analysis. Pattern matching, clustering algorithms, machine learning, or other forms of analysis may be applied to identify patterns or relationships of potential interest; such information may be stored for faster retrieval in caches or specialized data stores and made accessible to survey makers via data visualization tools. In addition, this data may be made accessible via a specialized data viewer in a more compact and summarized form. Data processing and analysis tools executed on the cloud-based data processing platform (such as suggested by elements 112 and 114 of FIG. 1) may use the data to recommend additional surveys to send to a survey taker or set of takers based on their interests, as inferred from responses to surveys and/or metadata associated with surveys. The functions and capabilities of the platform may also use the data to inform survey makers how best to modify their surveys to maximize user response rates, response reliability, and taker interest level

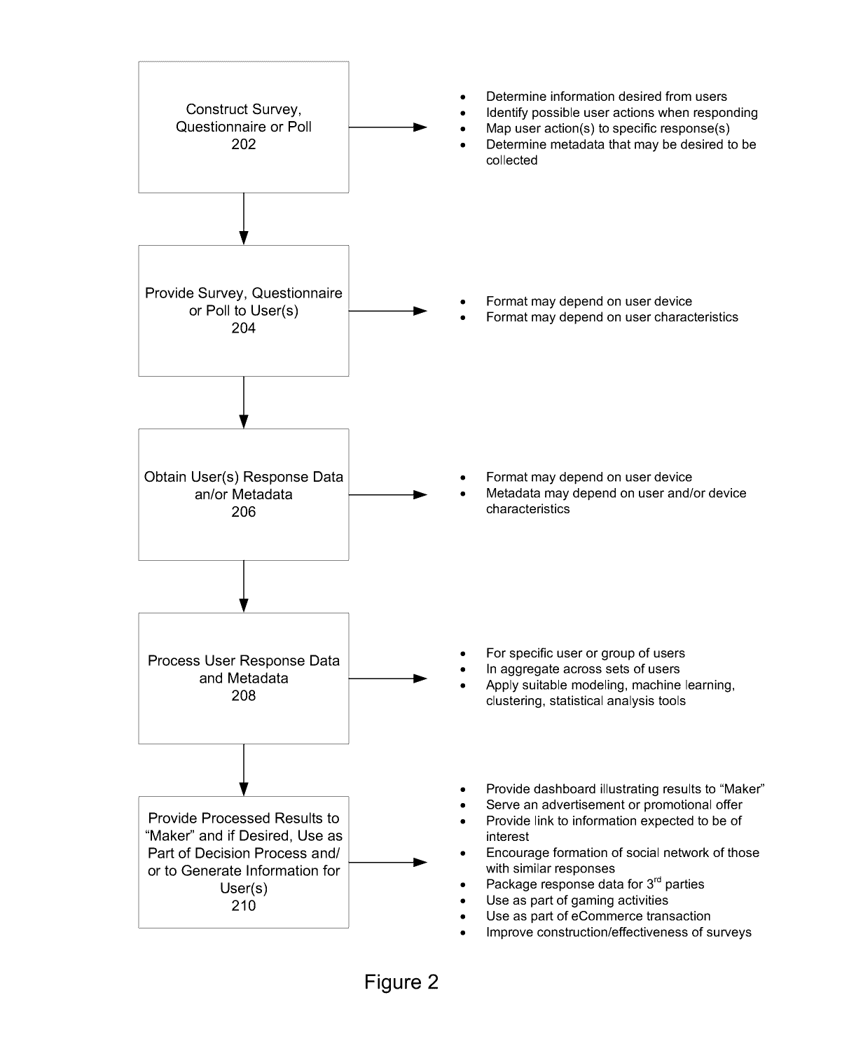

FIG. 2 is a flowchart or flow diagram illustrating a process, method, function, or operation that may be used in implementing or using an embodiment of the inventive system. As shown in the figure, a likely first step or stage in implementing or using an embodiment of the inventive system is to construct a survey, poll, questionnaire, or other form of content to present to a “taker” or device user 202. As indicated by the additional details or statements to the right of step 202, this step may include one or more of the following sub-processes:
Determining the information desired to be obtained from users;
Identifying one or more possible user actions that may be obtained when responding to a question or statement;
Mapping one or more specific user action(s) to specific response(s); or
Determining one or more types or categories of metadata that may be desirable to collect in addition to the explicit user response(s).

Next, the survey, poll, questionnaire, or other form of content is presented or delivered to the device user (the “taker”) 204. Note that as indicated by the additional details or statements, this step may include providing the survey, poll, questionnaire, or other form of content in a format (such as with regards to data structure, encoding, fields, record, etc.) that is in some way dependent upon the user's device characteristics (such as display screen, installed fonts or user interface elements) and/or the user's characteristics (such as age, level of education, location, previous browsing history, demographic characteristics, physical limitations, etc.). The survey, poll, questionnaire, or other form of content is typically delivered to the user's device as a web page that is interpreted and displayed to the user by a browser, browser plug-in, or application.

The user interacts with the questions or statements displayed to them (or to provided images, video, audio file, etc.) by interacting with the screen or display of the device. These interactions are forms of gestures, swipes, or similar motions. In some cases, the user provided interactions may include taking a picture or recording an audio file using the recording capabilities of the device. Data representing the user's responses and any desired metadata regarding the user's interactions with the device are captured and provided to a remote data processing platform 206 (an example of which is shown as element 108 of FIG. 1). Note that raw response data and/or metadata may be provided to the remote platform or pre-processed response data and/or metadata may be provided to the remote platform after being subjected to certain processes or operations in the device. As indicated by the additional details or statements, the format of the response data may depend upon the user's device and the metadata captured may depend on the user and/or device characteristics.

The data and metadata received by the remote data processing platform is then processed in accordance with a desired workflow 208. This processing may involve any suitable type of data manipulation, calculation, evaluation, ordering, etc., and may include application of a desired type or class of mathematical modeling, machine learning, optimization, clustering, statistical analysis, etc. The desired modeling or other operations or functions applied to the data and/or to the metadata may be controlled by a workflow that is defined by the “maker” and may be based on how the maker wishes to utilize the response data and/or metadata. Further, as indicated by the additional details or statements, the response data and/or metadata may be processed, analyzed, or evaluated for one or more of each user/taker, for a defined group or set of users/takers, or for all users/takers in aggregate.

Next, the processed response data and/or metadata may be provided to the “maker” via a dashboard, graph, table, or other suitable format. The provided data and/or metadata may be sent to the maker's mobile device or other computing device or workstation 210. In some cases, it may be desirable for the maker to define a workflow in which the remote platform or the maker's organization or infrastructure initiate an action or make a decision based on the data and/or metadata (either for a specific “taker”, a group or set of “takers”, or for all “takers” in aggregate). As indicated by the additional details or statements, such an action, event, or decision may include one or more of:
Presenting a survey taker with a set of possible actions or events that can be initiated;
Serving an advertisement or promotional offer;
Providing a link to information expected to be of interest;
Encouraging the formation of a social network of those with similar responses;
Packaging aggregate response data for 3rd parties;
Using as part of a gaming activity to alter a game flow or character;
Assisting in executing an eCommerce transaction; or
Improving the construction/effectiveness of surveys.

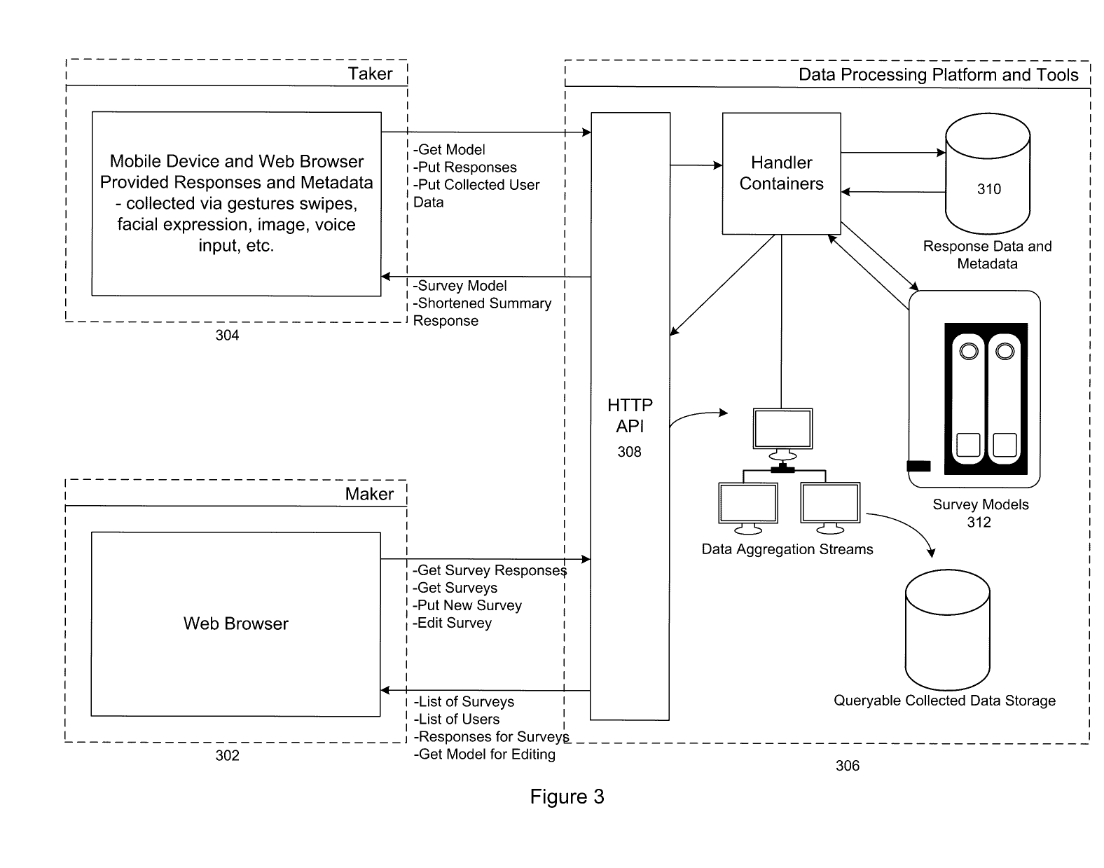

FIG. 3 is a block diagram illustrating aspects of the architecture of a system used to implement an embodiment of the inventive system and methods. As suggested by the figure, the system architecture includes three primary entities; the survey maker 302, the survey taker 304, and the remote data processing platform 306. The survey maker 302 is typically remotely located from platform 306 and may access the functionality and capabilities of platform 306 by virtue of being a “tenant” of the platform. The maker 302 may use a browser, application, or plug-in to access certain of the functionality of platform 306, such as those functions related to survey authoring or creation. As suggested by the text associated with maker 302 in the figure, the survey maker may interact with platform 306 using a suitable API or set of APIs 308. Using the browser (or application or plug-in) the maker 302 may perform one or more of the following operations or activities using a suitable command or instruction (such as “Get”, “Put”, etc.):
Get Survey Metadata;
   The metadata consists of creation date, publishing date, whether it's in draft, published, or closed mode, and the survey name
Get Survey Responses, metadata;
   Retrieve the aggregate of all responses collected for the survey
Get Surveys;
Create New Survey;
   Create a new survey with a given name
Update Survey metadata;
   Update the name of the survey
List of Surveys;
   List all of the surveys owned by the tenant
List of Users;
Responses for Surveys;
Get Model for Editing;
   The model is the description of the survey in a format that can be understood by a computing device; this consists of all questions, answers, styles and other customizations
Update Model;
   This is called when elements are updated in the survey design, such as cards, questions, answers, styles, and other customizations
Upload image for survey;
   Upload an image to be used in the survey
Delete survey;
   Delete a survey
Publish survey;
   Publish a survey so that users may take the survey; after publishing, the survey is no longer editable by the tenant
Close survey;
   Prevent the survey from being taken by further users; a survey may be closed so the tenant stops paying for services.

Similarly, a device user/survey taker 304 may use a browser, application, or plug-in to access the survey or poll and to provide responses (and metadata if desired by the survey maker) to the questions, statements, or content presented. As suggested by the text associated with taker 304 in the figure, the survey taker may interact with platform 306 using a suitable API or set of APIs 308. Using the browser (or application or plug-in) the taker 304 may perform one or more of the following operations or activities using a suitable command or instruction (such as “Get”, “Put”, etc.):
Get Model;
   The model describes the survey to the application; this consists of the cards, questions, answers, images, and other customizations—the model is interpreted by the application to render/display the survey
Put Responses;
   This is used to transmit the collected answers to questions back to the application—this may also return a link or data point(er) to the user to enable them to “see what others think” and understand others' responses to the survey
Put Collected User Data;
   This is used to transmit metadata about the user back to the system—this may include data such as software and hardware versions, how long it took for users to swipe different answers, geographic information, etc.

Platform 306 may include datastores used to store taker response data 310, (and if applicable, response associated metadata and/or taker associated metadata), one or more survey models or descriptions 312 (where a survey model is data describing all branding, styles, questions, images and actions that may be performed during or at the end of a survey by the taker). This set of data, styles, formats, etc. is typically created by a designer on behalf of the maker (302), and is interpreted by the taker (304) application to present the survey experience and ultimately collected the taker's responses. Element 310 is the primary datastore for response data. After a set of responses and its related metadata is collected and stored in 310, it is sent to various data aggregation streams to be processed in the background. At this point the survey taker can end the survey with their responses and metadata being stored. The background process(es) (data aggregation streams) perform multi-tenant processing, such as aggregating response counts for all surveys, for use by the survey business or other organizations.

In general, the architecture illustrated in FIG. 3 has, or is capable of providing, the following aspects, functions, processes, or characteristics:
a web based user/taker interface served over a mobile web browser
   the web browser makes an http request to the platform to receive the survey data model—the browser renders the survey for the survey taker. After the taker has finished the survey, the response(s) and any relevant metadata is sent to the platform;
on the platform is an API layer which handles and routes the http requests to stateless, short-lived, runtime containers which process the request(s)
   the containers manipulate the data in a platform database;
the survey maker user interface goes through the API layer to access the database and to obtain data, a display, a dashboard, statistics or analysis regarding the survey results and/or metadata;
the maker user interface may guide the maker in constructing a survey model; that model is sent via http to the platform for storage; and
data collected from the taker is sent from the mobile browser and from the platform's data storage containers to a cloud based aggregation stream. This is where many of the background data processing and analysis occurs. Full-system aggregation may be implemented, such that the business knows how many responses are collected for a survey (or all surveys) each day. Time series aggregation may also be implemented, so that the system has a record of how many responses are received per day for any particular survey. In addition, for certain customers or for premium surveys, the survey owner (the customer) may be notified regarding the survey results so that the “Maker” can use the data in near real-time as it is being collected and processed. Certain aggregate metrics may be precomputed, as survey data may be sufficiently large that it is not scalable to compute these on-demand.

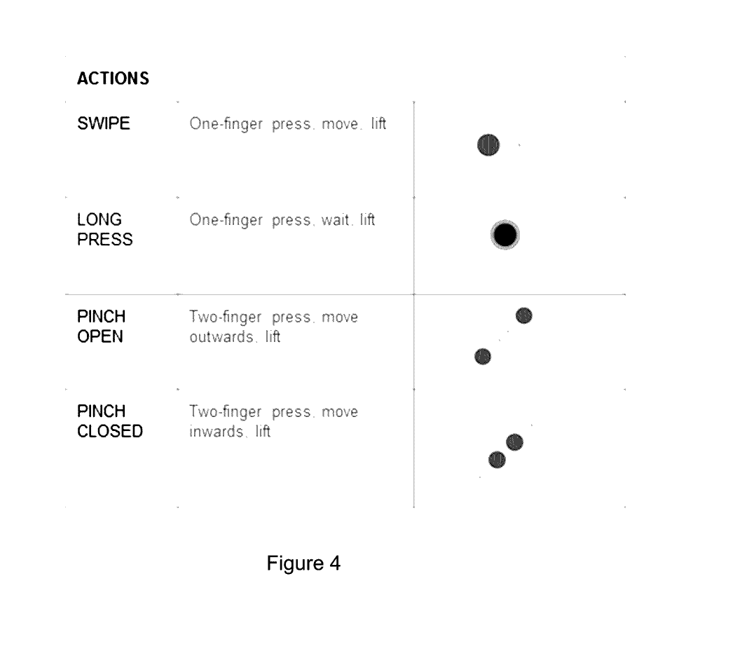

FIGS. 4-8 illustrate displays and implementation details that may be relevant to one or more embodiments or use cases of the inventive system and methods. These implementation details will be described in the context of one or more of the following use cases or survey maker/taker environments. As an introduction, note that the survey taker may be a customer, member of the public, or an employee, while the survey maker may be a business, opinion data collector, governmental entity, etc.

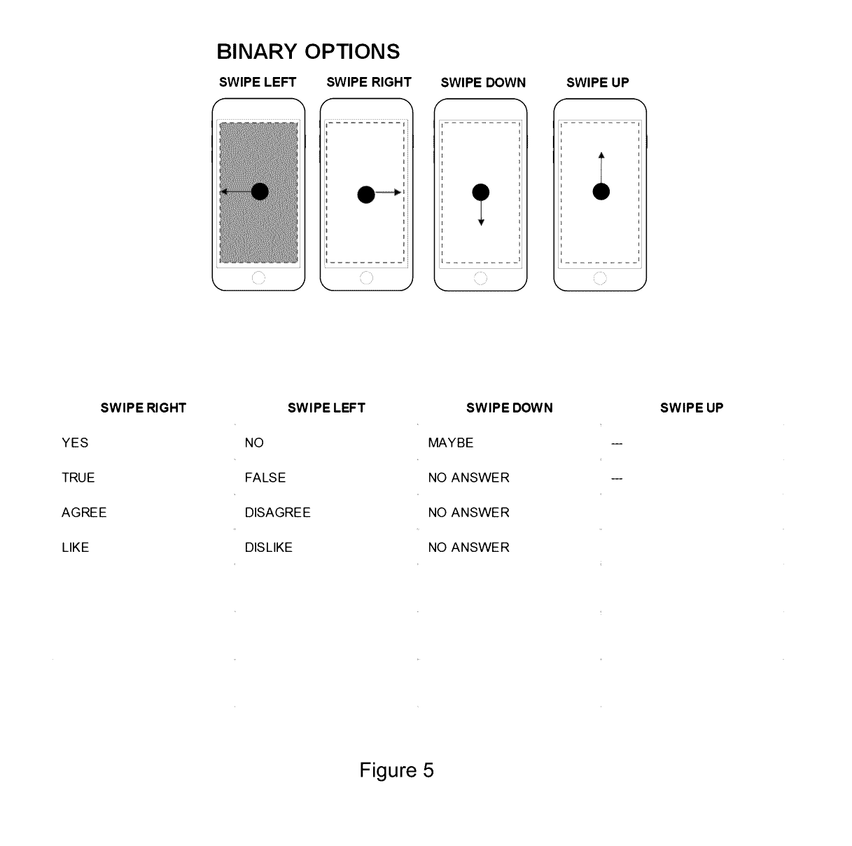

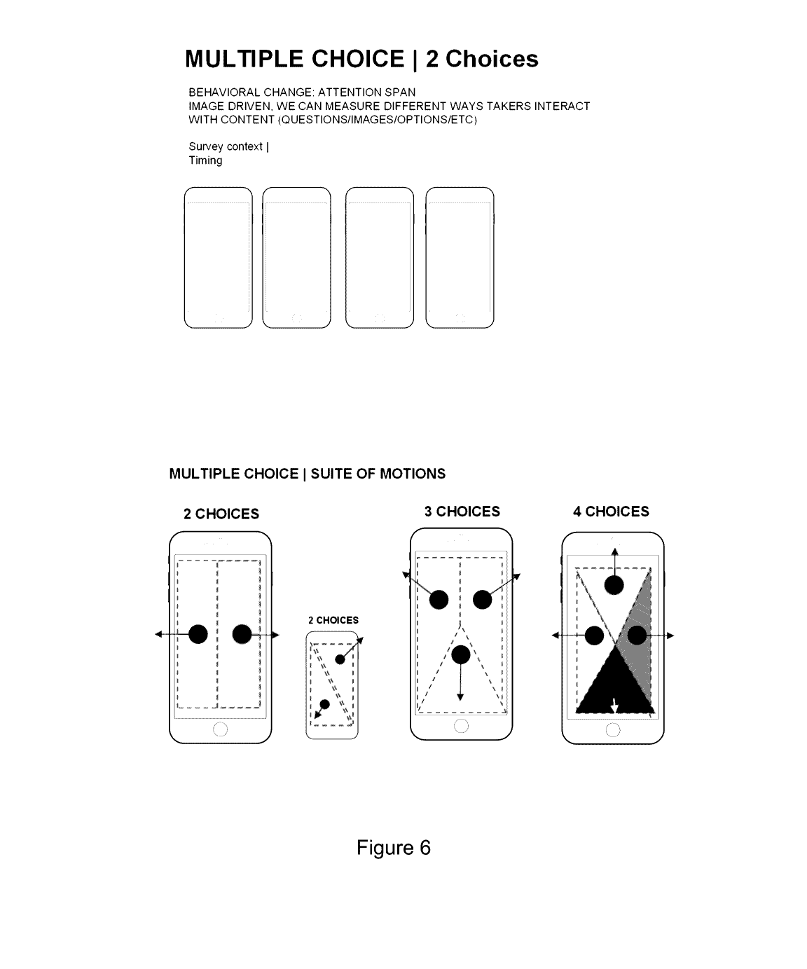

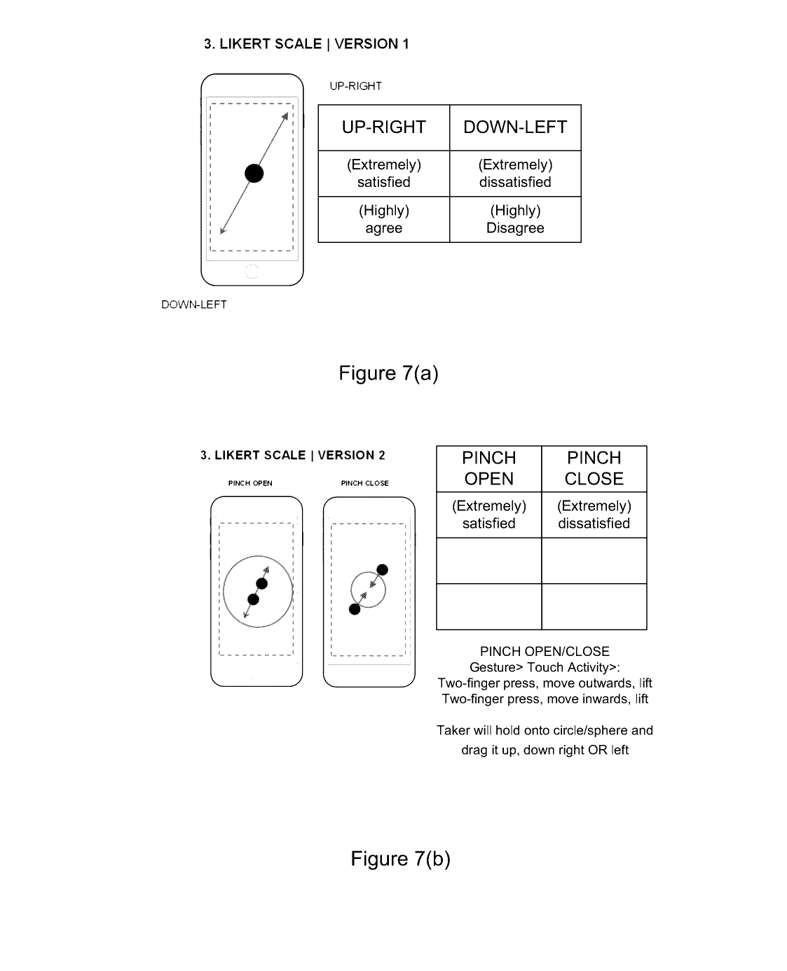

FIG. 4 is a diagram illustrating a set of user/taker actions or interactions with a device user interface/display that may be used in responding to a survey, poll, statement, or other form of content. These actions may be enabled by the device itself or provided by means of an application or plug-in provided to the device by the survey maker. FIG. 5 is a diagram illustrating a set of user/taker actions or interactions with a device user interface and an example of how they may be mapped to a survey taker's response to a survey, poll, statement, or other form of content. FIG. 6 is a diagram illustrating how a response to a multiple choice question may be generated by a taker through the interaction of the taker with their device display/interface and the indicated swipe or motion on the display screen (which, as indicated may depend upon the number of possible responses). FIG. 7(a) is a diagram illustrating how a response to a question in the form of a relative evaluation (in the form of a Linkert scale) may be generated by a taker through the interaction of the taker with their device display/interface and the indicated swipe or motion on the display screen. FIG. 7(b) is a diagram illustrating a second method by which a response to a question in the form of a relative evaluation (in the form of a Linkert scale) may be generated by a taker through the interaction of the taker with their device display/interface and the indicated swipe or motion on the display screen.

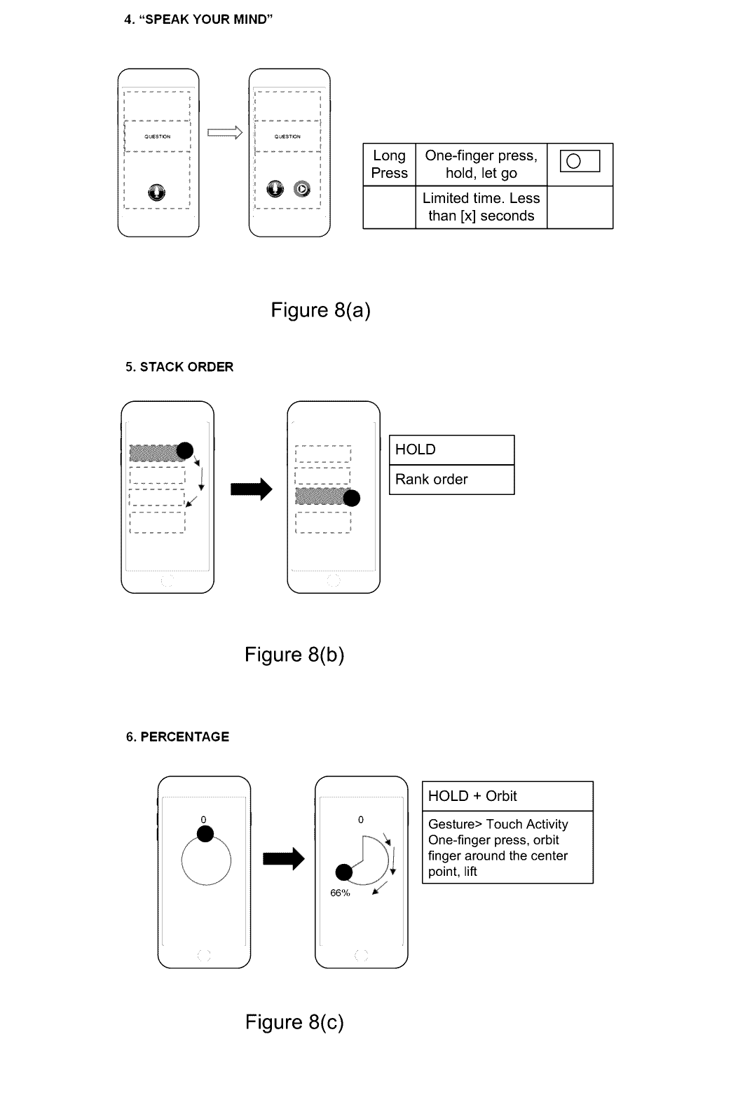

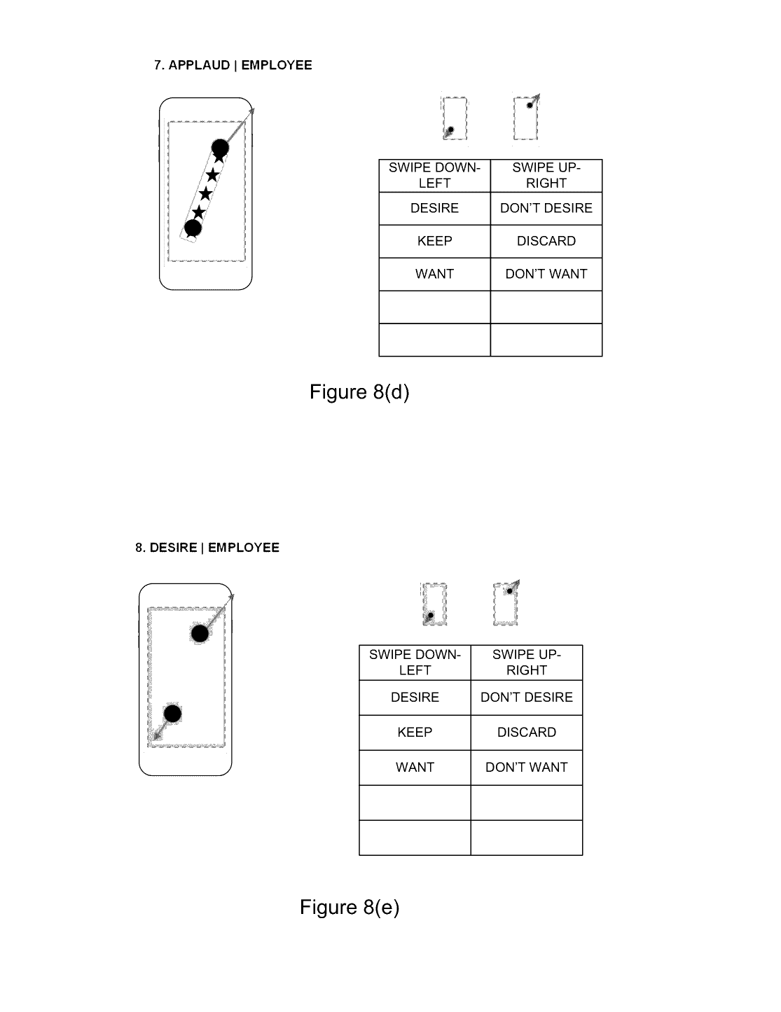

FIGS. 8(a) through 8(e) are diagrams illustrating additional types of taker actions that may be mapped to (or used to create a response to) a question, statement, presentation of content, survey, poll, etc. For example, FIG. 8(a) illustrates how a taker's audio input may be used to provide a response; FIG. 8(b) illustrates how a stacking or ordering of options or statements may be used to provide a response; FIG. 8(c) illustrates how a taker's selection of a percentage or relative approval of an option or statement may be used to provide a response; FIG. 8(d) illustrates how a taker's selection of a value on a scale of indicators (in this example, stars) may be used to provide a response; and FIG. 8(e) illustrates how a taker's movement or pinching/expanding action may be used to provide a response.

### EXAMPLE USE CASES

### Example 1

Problem: HR Departments and other survey makers looking for internal feedback, often send out long, cumbersome surveys to employees or groups of employees; as a consequence, response rates are often low and results often don't provide the survey maker with reliable or actionable solutions. Managers in many high turnover businesses are scored on their efficiency, and so there is a mismatch between management's objective and the way information is collected.
Use Cases:
   a. As an HR department, I want a more agile means to get feedback about employee satisfaction/dissatisfaction;
   b. As an HR department, I want help building a survey that will be user-friendly and provide me with actionable results.

### Example 2

Problem: Retail companies, looking for customers' in-store shopping experience feedback, often direct consumers to online survey forms at checkout; this requires the user to undergo an arduous process to access the survey. In many cases, incentives are used to try to persuade customers to take the survey (e.g., “Take this survey and be eligible to win $5,000”).
Use Cases:
   a. As a retail company, I want rapid feedback from consumers on exit from our store or during a shopping or check-out stage.

### Example 3

Problem: Companies that do quick, time-critical polling may still primarily rely on phone and in-person/on-street polling methods; as such, response rates rely on having sufficient man-power available to administer the polls.
   a. As a polling company/user, I want ability to create short, usable surveys for quick and simple result reporting.
   b. As a polling company/user, I want help getting people to take my poll.

### Example 4

Problem: Employees are asked to take long, cumbersome surveys by their HR department; when/if employees find the time to take the survey, they often are no longer in the office/at their desk and find the survey rather difficult to take on their mobile device.
Use Case:
   There are many “non-terminal” companies, where an employee is not issued a company computer. Many of these employees are the ones who do not have computers at home as they tend to be lower wage jobs. Embodiments of the inventive system would allow such employees to complete their surveys in an effective manner.

### Example 5

Problem: Traditional “buttons and boxes” surveys are not accessible for everyone or capable of being responded to in an effective manner by all possible takers. For example, people with limited manual dexterity, people with poor vision, people who do not have English as their primary language, people who have lower levels of literacy, etc. may find standard polls or surveys too difficult to respond to, and as a result participation rates among these takers may be low. For example, an embodiment of the inventive system and methods may be more suitable for survey takers that fall into one or more of the following categories:
   a. A paraplegic without use of both hands;
   b. A blind or sight impaired person (in this case they could use voice commands with gestures to respond);
   c. A person having limited language skills might prefer to use icons and images versus depending on text; or
   d. Similarly, for persons having relatively lower literacy levels, greater reliance on icons, images, or verbal inputs may be helpful.

### Example 6

Problem: Traditional “buttons and boxes” surveys provide limited contextual information beyond the answer provided by the taker. For example, the time it takes to answer a question is not tracked and for certain industries (fashion, food, consumer tech), the time spent reviewing a product may be as important as the response itself. Thus, in some cases the collection and processing of metadata related to (or associated with) a taker's responses may be valuable.
   a. A designer may desire to be able to compare the desirability of a set of products, and a standard yes/no response choice does not provide all of the available information. For example, a taker might spend a long time looking at a dress and ultimately select “no” versus an immediate “no” response.

In addition to the use cases, operating environments, and possible mappings of taker action(s) to survey/poll response(s) described, the inventive system and methods (in conjunction with certain of the response data, metadata processing, or analysis techniques mentioned) may be used to provide takers with one or more of (a) an indication of how their response or responses compare to other survey takers, or (b) a set of possible actions or events that a taker may initiate after taking the survey. These events or actions may be part of participating in a business activity, making a purchase, contributing to a charity, volunteering to assist with a task, requesting further information, etc.

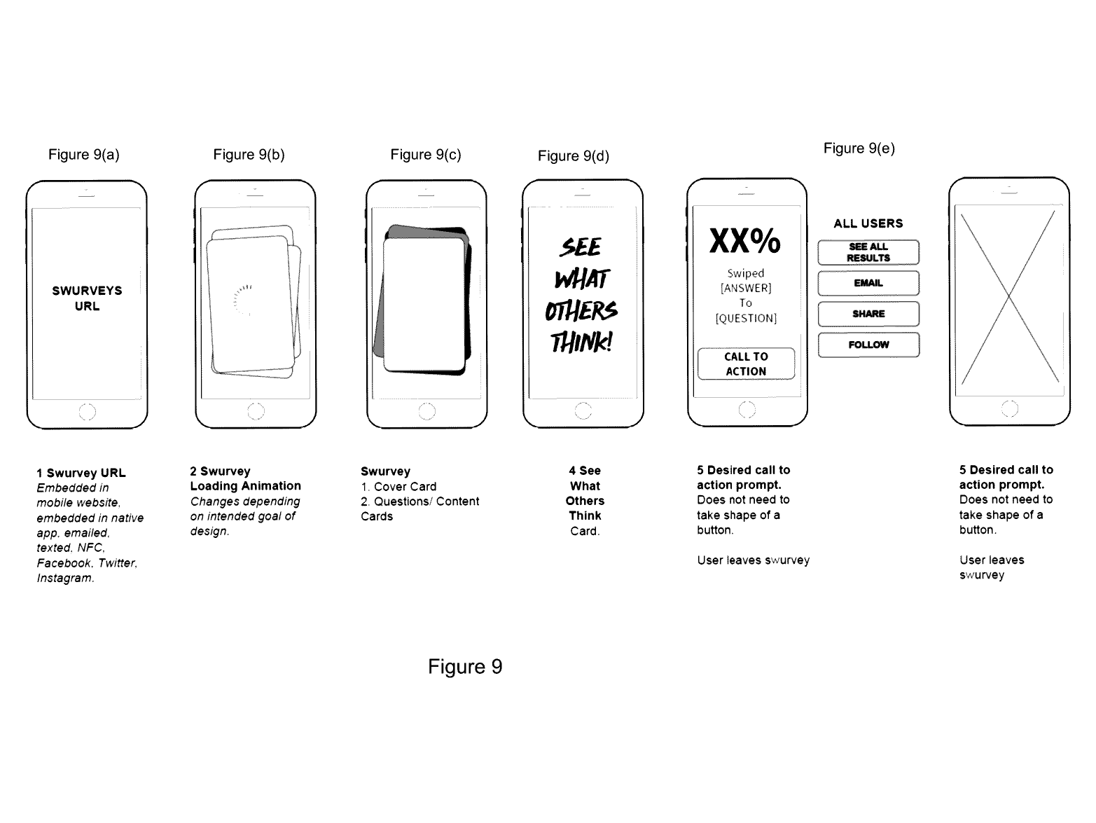

FIG. 9 is a diagram illustrating a possible set of screen displays and an overall process flow that may be presented to a survey taker as part of an implementation of an embodiment of the inventive system. It is noted that in some of the displays, reference is made to a “survey”; this is a name or identifier given by the inventors to the type of survey or poll (and the associated system) that they have invented and implemented. In some embodiments, a survey may employ audio and/or visual cues to confirm to a taker that they have submitted a response or completed their interaction with a question or card.

Referring to the figure, in one embodiment (as suggested by the display in FIG. 9(a)), based on a received or accessed address/location (such as a URL provided by a message, an embedded link, a text, or another suitable form of communication or data transfer), a browser in the taker's device navigates to a location containing the landing page or animation for the survey or for the survey provider. As suggested by FIG. 9(b), accessing the landing page may initiate an animation (such as a deck of cards or moving shapes), where the animation may feature shapes or movements intended to communicate certain information to the taker. In some embodiments, the animation may be presented while a survey or poll is loading; the animation may provide the taker with information regarding how to register a response and may tell a user what they can expect to receive as an incentive or payment for completing the survey or poll.

FIG. 9(c) shows a cover card or title card for the survey or poll; subsequent cards may show survey or poll questions, statements, content, images, a link to a web-page, etc. At the end of a stack or set of cards, a card may be displayed that offers the taker an opportunity to “see what others think” (as suggested by FIG. 9(d)); that is, to learn how many and/or what percentage of takers have the same responses as the taker. This is a mechanism for permitting a taker to examine the processed results of the response data and/or metadata in order to understand how their responses compare to others.

In implementing this “see what others think” function, the inventive system may select one or more data points to display to the survey taker or other user; the data point(s) may be selected at random or in accordance with a condition or rule defined by the survey maker with the intention of presenting a data point that has the most favorable results to encourage the selected action. Machine learning techniques may be used to select and present the data point that positions a taker in the most advantageous position to drive the selected action. A “see all results” “button” or selectable element may be used to enable a survey taker or other user to access and view the survey responses from all takers.

FIG. 9(e) shows an example screen display that might be presented to a taker; in this display a percentage value is shown that represents the percent of takers that responded to a specific question or statement in a specific manner. In addition, the display may feature a “call to action” button or prompt; this activate-able user interface element may be used to present a taker with a list or set of possible actions or events that the taker may initiate or otherwise participate in.

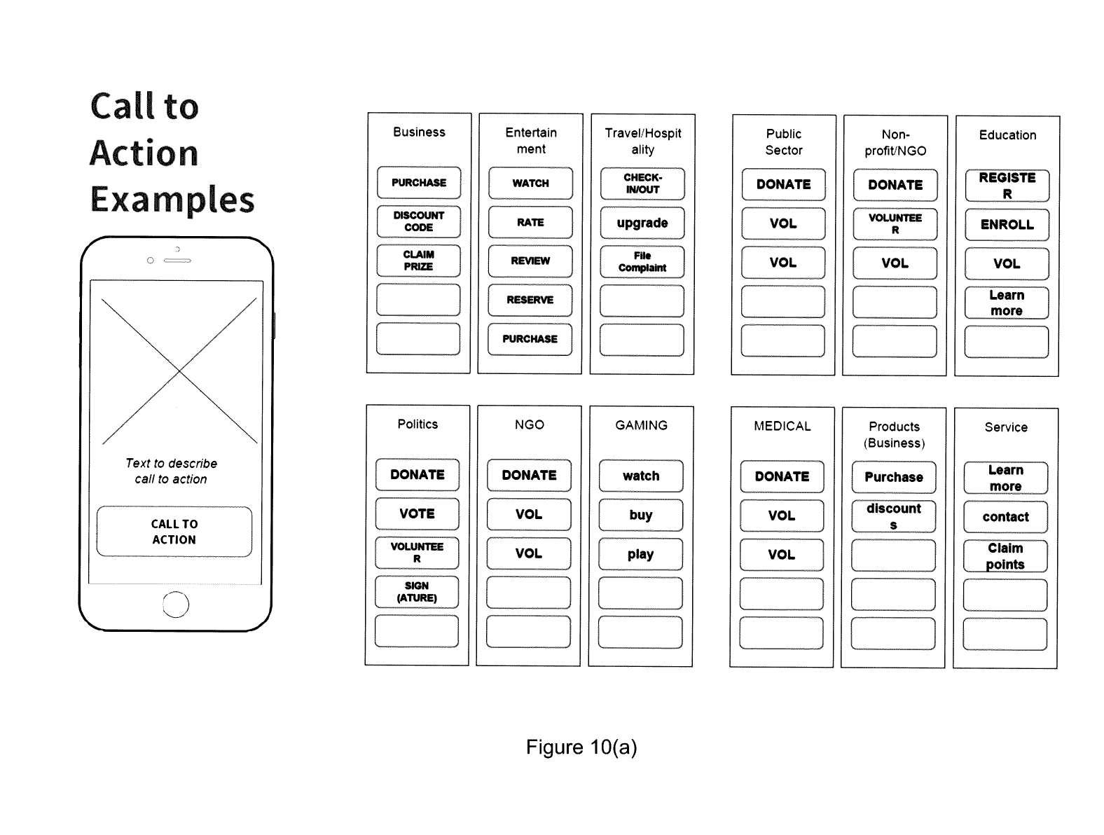

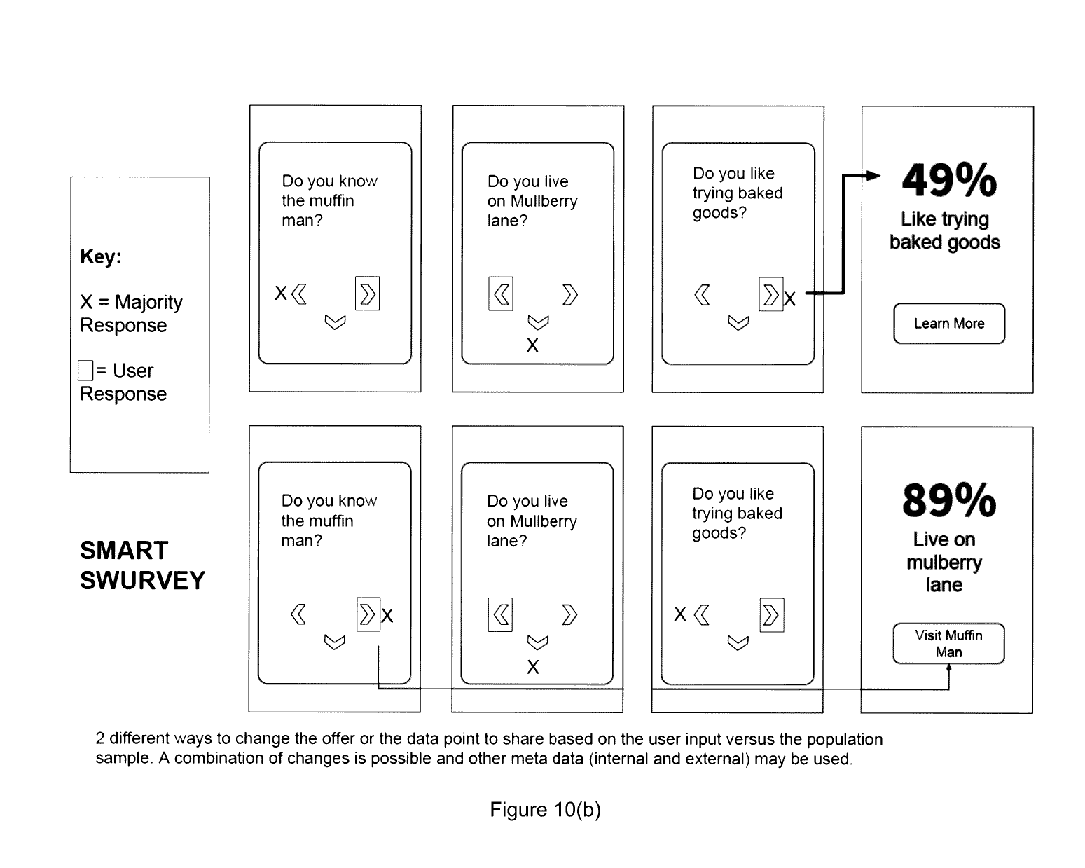

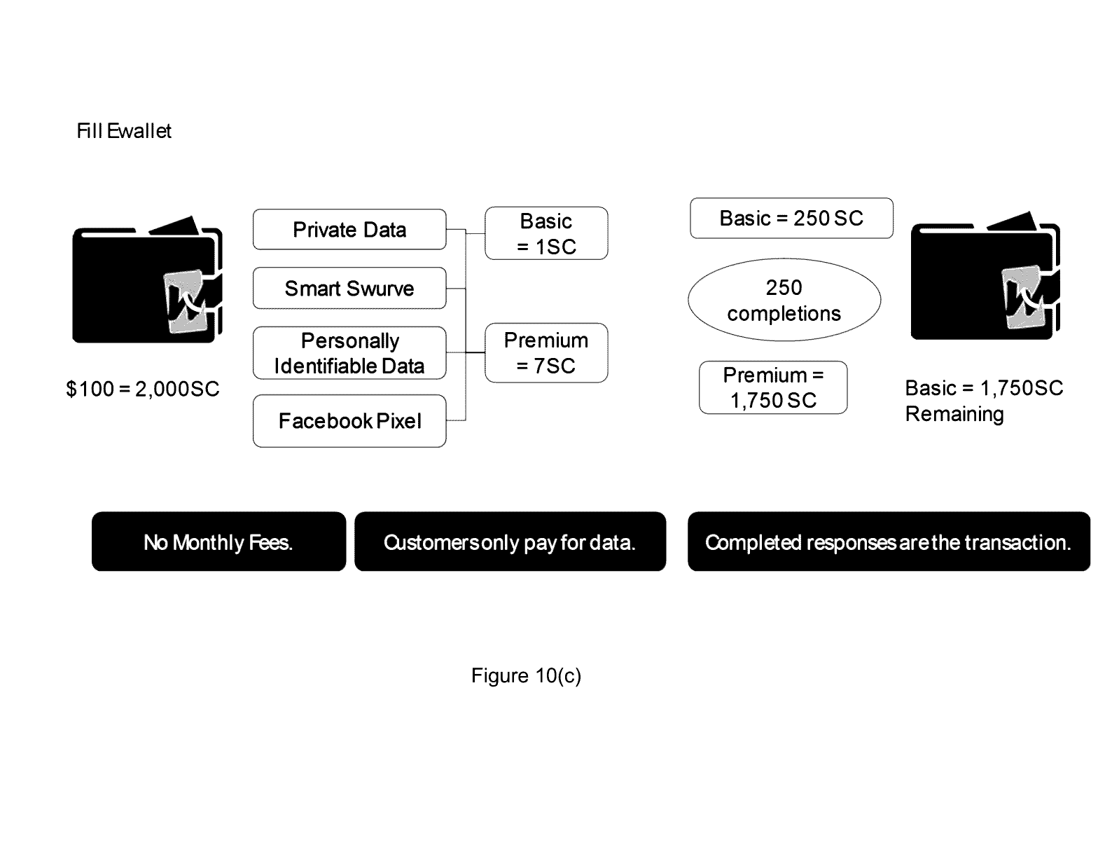

Examples of such actions are illustrated in FIG. 10(a), which is a diagram illustrating examples of the types of actions or events that a survey or poll taker may initiate as part of completing the survey or poll, or in response to receiving the results of processing the data and/or metadata associated with the survey or poll. These actions or events include making a donation, volunteering for a task or activity, initiating a purchase transaction or reservation, registering for an event, accessing further information about a topic, accessing a video or game, entering a competition, “signing” a petition, submitting an opinion or preference, redirecting the taker to a specific web-site, generating a message, etc.

Note that in some embodiments, the set of actions or events that may be presented to a survey taker or set of takers may depend on or be determined by the survey responses and/or associated metadata provided by the taker, by a set of takers, or by all takers of the survey. For example, certain survey questions may be associated with presenting certain actions or events, a certain response to those questions may be associated with presenting certain actions or events, a failure to respond to certain questions may be associated with presenting certain actions or events, a certain action or event may be presented only if a specific number of takers respond or respond in a certain way to a question, etc. The data collected in aggregate from all survey takers and their eventual conversion action (i.e., taking an action at the end) may be fed into a machine learning algorithm. This would allow the use of both aggregate and individual data and metadata to “predict” the action that a user is most likely to engage in at the end of a survey.

FIG. 10(b) is a diagram illustrating how a survey taker's response or responses as compared to those of other takers may be used to determine which action(s) to encourage and how to select those actions. As shown in the figure, the relationship between the specific taker's response or responses, and those of the larger set of survey takers may be indicative of the common factors between the specific taker and the others, which may then be used to determine which action or opportunity to promote or suggest to the specific taker. As suggested by the figure, the common factor (or the survey responses with which the specific taker and the larger group are most in agreement) may be used as the basis for generating a suggested action, a promotional opportunity, an invitation, etc.

FIG. 10(c) is a diagram illustrating aspects of a process for generating revenue from providing the services related to survey or poll creation, distribution, and response data and metadata processing that are associated with an embodiment of the inventive system and methods. Note that this revenue generating process may be implemented or controlled by the operator of platform 108 illustrated in FIG. 1 and/or Platform 306 illustrated in FIG. 3, for example.

As shown in the figure, in some embodiments, the completion of a survey or poll by a taker may be an event that is associated with a transaction cost or the application of a pricing model. This results in the entity for which the survey or poll is distributed (such as the survey maker) being charged for services based on one or more of (although this list is not meant to be exhaustive or restrictive):
(a) the type of survey or poll;
(b) the added value services provided to the entity by the service platform (such as survey authoring tools, specialized workflows for data or metadata processing, access to 3rd party data analysis or visualization tools, access to an advertising server or platform for use in determining an advertisement or offer to present to a taker);
(c) the type or amount of data processing applied to the survey takers' responses and/or associated metadata;
(d) the amount or type of response data and/or associated metadata provided to the entity;
(e) the number of survey or poll takers that submit responses;
(f) the provision of any specialized user interface elements to takers for purposes of responding to the survey or poll; or
(g) the type or number of actions or events that may be provided to takers (or implemented for their benefit) after completion of the survey or poll, etc.

In some respects, embodiments of the inventive system and methods represent a transactional-based system for creating, distributing, and processing the results of a survey or poll. In these embodiments, the unit of transaction is the completion or submission of responses to a survey or poll. In some cases, a customer (i.e., an entity that wishes to distribute a survey or poll and receive response data and/or metadata from takers of the survey or poll) may be asked to pre-fund an electronic “wallet” and then have any costs or pricing applied against the contents of the wallet. This may be accomplished by converting negotiable funds into Surveys credits (SC), where a certain amount of such credits will be used to pay for a particular campaign.

Note that the relatively low infrastructure cost and the near-negligible transaction cost associated with the inventive system and methods enable a potentially economically viable business because it is scalable and takes advantage of currently available cloud infrastructure resources (multi-tenant architectures, SaaS concepts) and client side applications.

Note also that the use of per (taker) response pricing connects the customer's success to the success of the system operator. The captured metadata may be used by a customer to influence the construction or another aspect of a survey or poll, in an effort to create higher response rates from takers (and thereby generate higher fees for the platform operator). Premium features or value-adds, such as “smart” Surveys (which may use the answers provided by a taker as compared to the answers provided by a larger set of takers and/or metadata analysis) may be associated with higher fees. As an example, a basic Survey service that does not leverage the associated metadata may cost 1 SC per response, while a “smart” Survey service that includes the provision of metadata (and possibly certain processing or analysis) may cost as much as 20 SC per response.

In another use case, an educator might use an embodiment of the inventive system and methods for purposes of conducting a performance evaluation. Yet another use might be for enabling the collection of “votes” cast in an election or meeting. Another use might be by a medical professional for purposes of monitoring the status of patients, particularly those with limited mobility (e.g., by observing if they respond, and how they respond, to a simple survey regarding their condition, mood, etc.).

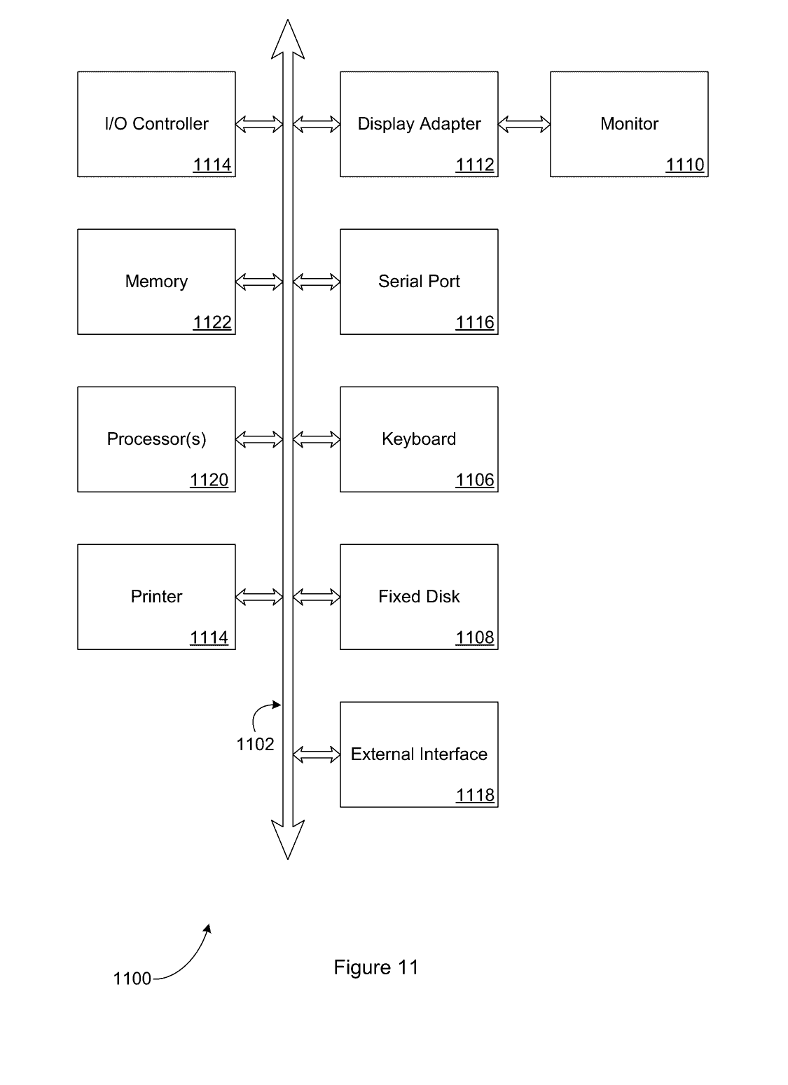

In accordance with one embodiment of the invention, the system, apparatus, methods, processes, functions, and/or operations described herein may be wholly or partially implemented in the form of a set of instructions executed by one or more programmed computer processors such as a central processing unit (CPU) or microprocessor. Such processors may be incorporated in an apparatus, server, client or other computing or data processing device operated by, or in communication with, other components of the system. As an example, FIG. 11 is a diagram illustrating elements or components that may be present in a computer device or system 1100 configured to implement a method, process, function, or operation in accordance with an embodiment of the invention. The subsystems shown in FIG. 11 are interconnected via a system bus 1102. Additional subsystems include a printer 1104, a keyboard 1106, a fixed disk 1108, and a monitor 1110, which is coupled to a display adapter 1112. Peripherals and input/output (I/O) devices, which couple to an I/O controller 1114, can be connected to the computer system by any number of means known in the art, such as a serial port 1116. For example, the serial port 1116 or an external interface 1118 can be utilized to connect the computer device 1100 to further devices and/or systems not shown in FIG. 11, including a wide area network such as the Internet, a mouse input device, and/or a scanner. The interconnection via the system bus 1102 allows one or more processors 1120 to communicate with each subsystem and to control the execution of instructions that may be stored in a system memory 1122 and/or the fixed disk 1108, as well as the exchange of information between subsystems. The system memory 1122 and/or the fixed disk 1108 may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, JavaScript, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

What is claimed is:

1. A system for creating, distributing, and evaluating the results of a survey or poll taken by one or more survey takers by submitting a response using a mobile device, comprising:
a set of executable instructions stored in an electronic data storage element;
an electronic processor programmed to execute the set of instructions, which when executed cause the system to implement a process or processes to
enable a survey maker to create a survey or poll;
enable the created survey or poll to be distributed to the one or more survey takers;
receive data representing each taker's response to the distributed survey or poll, the received data including data representing one or more non-textual interactions with a display of a mobile device associated with the taker;
process the received data to determine each taker's responses to the survey or poll;
generate a display or other form of communication of a result of the processing of the received data to the survey maker;
present to a survey or poll taker, or to a set of survey or poll takers, one or more actions or events that may be initiated, the one or more actions or events based on the taker or takers responses; and
determine a charge or cost for the services provided by the system.

2. The system of claim 1, wherein the process of enabling a survey maker to create a survey or poll further comprises one or more of
determining one or more statements, questions, or content elements to present to a taker of the survey or poll;
determining a response or range of responses that the taker may make to the presented statement, question, or content element;
determining one or more non-textual interactions with a user interface of a mobile device that the taker may provide in response to the presented statement, question, or content element; and
mapping at least one of the one or more non-textual interactions to the response or range of responses.

3. The system of claim 2, wherein the one or more non-textual interactions with the user interface of the mobile device depend on a characteristic of the device.

4. The system of claim 2, wherein the one or more non-textual interactions with the user interface of the mobile device are provided or supplemented by an application, set of executable instructions, or plug-in provided by the survey maker or the operator of the system.

5. The system of claim 2, wherein the one or more non-textual interactions with the user interface of the mobile device depend on a characteristic of the taker.

6. The system of claim 1, wherein the received data representing a response to the distributed survey or poll includes data representing one or more of a swiping motion, a selection of one of a plurality of presented options, a movement of a slider along a scale, or a selection of an image.

7. The system of claim 1, wherein the process or processes further comprise receiving metadata associated with the one or more non-textual interactions with the display of the mobile device, the received metadata representing one or more of:
an indication of the pressure applied by the survey or poll taker when entering their response;
an indication of the time between when a question, statement, or image is presented and the survey or poll taker enters their response; or
an indication of the time required for the survey or poll taker to enter their response to a set of questions, statements, or images.

8. The system of claim 7, wherein the process or processes further comprise processing the received metadata to determine or infer a relationship or association between the metadata and a taker's response or between the metadata and the conditions under which a response was made.

9. The system of claim 1, wherein the one or more actions or events that the survey taker may initiate based on the taker's responses and or metadata include:
executing a purchase transaction;
generating a message;
generating a request for further information; or
navigating to a specified web page.

10. The system of claim 1, wherein determining a charge or cost for the services provided by the system include determining a charge or cost based on one or more of:
a number of takers who respond;
a number of an action or event initiated by takers;
a total number of takers to whom the survey or poll is distributed; or
a value of one or more transactions initiated by a taker or takers as a result of taking the survey or poll.

11. The system of claim 1, wherein the process or processes include maintaining an account for each of a plurality of survey makers, wherein maintaining an account further comprises:
permitting access to an account upon providing appropriate authentication data;
evaluating the authentication data to determine if the authentication data is valid; and
providing access to one or more services of the system upon successful validation of the authentication data.

12. The system of claim 1, further comprising generating a display of a survey or poll taker's responses and presenting the display to the taker.

13. The system of claim 1, further comprising generating a display of the responses provided by a plurality of survey or poll takers and presenting the display to each of the plurality of takers.

14. A method for conducting a survey or poll, comprising:
receiving authentication data for a survey maker account from a user at a survey or poll data processing platform;
evaluating the received authentication data to determine if the authentication data is valid;
if the authentication data is valid, then providing the user access to a set of processes for constructing the survey or poll;
distributing the survey or poll to a plurality of possible survey takers;
receiving from at least some of the plurality of survey takers data generated by the survey takers device, the data representing the takers non-textual interactions with a user interface of their device in response to the survey or poll;
receiving from at least some of the plurality of survey takers metadata associated with the takers interactions in response to the survey or poll;
processing the received response data or metadata;
based on the processed response data or metadata, providing one or more of the survey takers with an option to initiate an event or action; and
determining a charge or cost for the services provided by the platform to the survey maker account.

15. The method of claim 14, wherein the set of processes for constructing the survey or poll include one or more of identifying potential survey takers, identifying a set of possible survey taker responses, identifying one or more possible survey or poll taker non-textual interactions with a user interface of a device, or mapping a possible taker response to a non-textual interaction.

16. The method of claim 14, wherein the plurality of possible survey takers is determined by one or more of a common attribute, interest, or activity, or membership in an organization or group.

17. The method of claim 14, wherein the data representing the takers non-textual interactions with a user interface of their device in response to the survey or poll include data representing one or more of a swiping motion, a selection of one of a plurality of presented options, a movement of a slider along a scale, or a selection of an image.

18. The method of claim 14, wherein the received metadata represents one or more of:
an indication of the pressure applied by the survey or poll taker when entering their response;
an indication of the time between when a question, statement, or image is presented and the survey or poll taker enters their response; or
an indication of the time required for the survey or poll taker to enter their response to a set of questions, statements, or images.

19. The method of claim 14, wherein the one or more actions or events that the survey taker may initiate include:
executing a purchase transaction;
generating a message;
generating a request for further information; or
navigating to a specified web page.

20. The method of claim 14, wherein determining a charge or cost for the services provided by the system include determining a charge or cost based on one or more of:
a number of takers who respond;
a number of an action or event initiated by takers;
a total number of takers to whom the survey or poll is distributed; or
a value of one or more transactions initiated by a taker or takers as a result of taking the survey or poll.
